(19) United States
(12) Patent Application Publication
(10) Pub. No.: US 2026/0003307 A1
(43) Pub. Date: Jan. 1, 2026

(54) PRINTING FLUID MIXING

(71) Applicant: HEWLETT-PACKARD DEVELOPMENT COMPANY, L.P., Spring, TX (US)

(72) Inventors: Peter NEDELIN, Ness Ziona (IL); Mark SANDLER, Ness Ziona (IL)

(73) Assignee: HEWLETT-PACKARD DEVELOPMENT COMPANY, L.P., Spring, TX (US)

(21) Appl. No.: 19/112,881

(22) PCT Filed: Sep. 20, 2022
(86) PCT No.: PCT/US2022/044125

§ 371 Date: Mar. 18, 2025

(51) Int. Cl. G03G 15/10; B01F 21/00; B01F 21/10; B01F 27/50; B01F 31/86; B01F 35/21; B01F 35/213; B01F 35/22; B01F 35/221; B01F 35/71; B01F 101/35; G03G 9/16; G03G 15/00

(52) U.S. Cl. CPC G03G 15/105; B01F 21/02; B01F 21/10; B01F 21/30; B01F 27/50; B01F 31/86; B01F 35/213; B01F 35/2134; B01F 35/2202; B01F 35/2211; B01F 35/2218; B01F 35/712; B01F 35/7176; G03G 9/16; G03G 15/556; B01F 2101/35; B01F 2215/044; B01F 2215/045

(57) ABSTRACT

According to an example, a mixing device comprises a first chamber including a solute addition member and a first mixer, a second chamber including a second mixer, a printing fluid pump, and a controller operatively connected to the solute addition member, the pump, the first mixer, and the second mixer. The controller is to control the pump to move printing fluid towards the printing fluid tank based on a printing fluid density level in the printing fluid tank, to control the solute addition member to add solids based on the printing fluid density level, and to control the first mixer and the second mixer to mix the added solids with the printing fluid moved by the pump.

### BACKGROUND

Liquid electro-photography (LEP) printing systems form images on substrates by transferring printing fluid profiles thereon. To obtain the printing fluid profile, printing fluid is selectively transferred to a photoconductive surface based on a voltage difference. In some examples, the printing fluid used in a transfer operation may be electrically conductive printing fluid including solids such as pigmented resins.

### BRIEF DESCRIPTION OF DRAWINGS

Features of the present disclosure are illustrated by way of example and are not limited in the following figure(s), in which like numerals indicate like elements, in which:

FIG. 1 shows a schematic drawing illustrating a mixing device comprising a first chamber and a second chamber, according to an example of the present disclosure;

FIG. 2 shows a schematic drawing illustrating a mixing device comprising a sensor to measure a printing fluid density level in a printing fluid tank, according to an example of the present disclosure;

FIG. 3 shows a schematic drawing illustrating a mixing device comprising a controller to control a first mixer and a second mixer, according to an example of the present disclosure;

FIG. 4 shows a schematic drawing illustrating a mixing device comprising an inline mixer in a first chamber and a sonotrode in a second chamber, according to an example of the present disclosure;

FIG. 5 shows a method for modifying a printing fluid density level in a printing fluid tank, according to an example of the present disclosure;

FIG. 6 shows a method for modifying a mixing speed of an inline mixer and a frequency of a sonotrode, according to an example of the present disclosure;

FIG. 7 shows a schematic drawing illustrating a printing system including a printing fluid tank and a mixing device, according to an example of the present disclosure

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Liquid electro-photography (LEP) printing systems are used to generate images by transferring a printing fluid profile to a printing substrate. To generate the printing fluid profile, a surface of a photoconductive element of the printing system is electrically charged, selectively discharged, and then, printing fluid developers (e.g., binary ink developers) selectively transfer printing fluids to the surface of the photoconductive element based on a voltage difference. Once the printing fluid profile is generated on the photoconductive element, the printing fluid profile is transferred to a subsequent transfer element (e.g., an intermediate transfer member or a printing substrate).

In LEP printing systems, the transfer of the printing fluid to the surface of the photoconductive element takes place based on the voltage difference between the printing fluid developer and the surface of the photoconductive element. In some examples, the printing fluid may be a combination of liquid and solid, such as 98% liquid and 2% solid by weight. The liquid may be an oil or another type of liquid, and the solid may be a pigmented resin or another types of solid. Similarly, the liquid carrier may be a dielectric oil or synthetic isoparaffinic hydrocarbon solvents. In some examples, the oil may comprise a number of oils of different molecular weights, as well as a number of dissolved materials such as charge active agents, and stabilization compounds, among others.

Prior to a printing fluid transfer operation, the printing system supplies a printing fluid developer with printing fluid. In some examples, the printing fluid may be pumped from a printing fluid tank storing printing fluid towards an inlet region of the printing fluid developer. However, while the printing fluid transfer is taking place, all the pumped printing fluid may not be transferred to the surface of the photoconductive element. As used herein, a portion of pumped printing fluid that is not transferred to the surface of the photoconductive element may be referred to as unused printing fluid. In some examples, the unused printing fluid may be recovered via a plurality of recovery operations. Examples of recovery operations include collecting the unused printing fluid using a printing fluid tray, using a sponge roller for absorbing the unused printing fluid, using a squeezer roller for recovering unused printing fluid that has been absorbed by the sponge roller, using a cleaner roller for cleaning the developer roller, or using a wiper blade to recover unused printing fluid from the cleaner roller.

As used herein, the term “printing fluid” will be used to refer to a combination of liquids and solids. The liquid may correspond, for instance, with an oil such as a dielectric oil. The solid may be a pigment or another type of solid, such as pigmented resins in addition to other compounds. In some examples, a printing fluid used in a printing transfer operation may include 98% liquid by weight and 2% solid by weight. However, other different solid-to-liquid weight ratios may be possible.

Recovering unused printing fluid reduces the overall printing fluid consumption associated to a transfer operation carried out in a printing system, thereby leading to a reduction of the cost per copy. However, in some examples, the recovered printing fluid may include a different solid-to-liquid weight ratio compared to the printing fluid stored in the printing fluid tank. As a result, the addition of unused printing fluid to the printing fluid tank may result in a change the density of the printing fluid stored in the printing fluid tank. In addition, in some examples, printing fluid stored in the printing fluid tank may evaporate, thereby leading a change in the printing fluid density. As a result of the change in the composition of the printing fluid stored in the printing fluid tank, the printing fluid profile generated on surface of the photoconductive element may be non-uniform over the printing fluid transfer operation, thereby leading to image quality defects. Examples of image quality defects include color inconsistency and a faulty transfer of printing fluid towards the surface of the photoconductive element (e.g., absence of transfer of printing fluid or excessive transfer of printing fluid).

Disclosed herein are examples of printing systems, mixing devices, and methods for reducing variations in the composition of a printing fluid stored in a printing fluid tank.

According to some example, a mixing device may be used for adjusting the solid-to-liquid weight ratio of printing fluid stored in a printing fluid tank of a printing system. As previously explained, throughout the transfer operations, a solid-to-liquid weight ratio may change as a result of the addition of recovered printing fluid into the printing fluid tank. Also, in other examples, fresh printing fluid with a different solid-to-liquid weight ratio may be added to the printing fluid tank. These factors may lead to variations in the composition of the printing fluid stored in the printing fluid tank. In some examples, to modify the proportion of solid with respect to liquid, additional solids may be added into the printing fluid tank. However, due to the particle size of the solids, mixing operations to decrease a particle size of the solids may have to be carried out prior to adding the solids to the printing fluid tank.

According to an example, a mixing device may be used to modify a solid-to-liquid weight ratio of a printing fluid stored in a printing fluid tank. The mixing device may comprise a solute addition member to add solid particles to the printing fluid. To effectively mix the printing fluid with the solid particles, the solute addition member may supply a first chamber of the mixing device with the solids. The first chamber may receive printing fluid from an external printing fluid supply (for instance, a carrier liquid supply of or a printing fluid supply containing a known composition) or from the printing fluid tank.

In some examples, a solute addition member of a mixing device may provide the first chamber with particles having a particle size from 5 mm to 10 mm. In an example, the solute addition member supplies particles having a particle size from 8 mm to 10 mm. In some examples, the solute addition member may feed the first chamber with 10% to 15% of solid particles by printing fluid weight. In an example, a solute addition member may supply the first chamber of the mixing device at a solid feed rate of 60 grams of solids per minute. However, alternative solid feed rates may be possible, such as a feed rate within a range from 10 grams/minute to 60 grams/minute.

As used herein, the term “solid feed rate” will be used to refer to a quantity of solids per unit of time added by a solute addition member. In an example, the solid feed rate may refer to a weight proportion between the added solids and the printing fluid received by the chamber per unit of time. As previously explained, the added solids may include pigmented resins.

To reduce the particle size of the solids added by the solute addition member, the first chamber may include a mixer to break up the added particles. In some examples, a shear force may be applied using the mixer. Examples of mixers include propellers, inline mixers, helical mixers, colloid mills, and static mixers. In some examples, a composition exiting the chamber may include particles up to 2 mm. However, the particles present in the composition may have to be further reduced before being added to the printing fluid tank.

To obtain a composition having a particle size within an admissible range, an additional mixing operation may have to be performed. In an example, the admissible particle size range may be a particle size from 1 micron to 25 microns. In other examples, the admissible particle size range may be defined by a mean particle size from 5 microns to 7 microns, with less than 5% of particles having a particle size below 1.5 microns and less than 5% of particles having a particle size above 20 microns. To reduce the particle size to admissible levels, the mixing device may further comprise a second chamber including a second mixer, the second mixer to reduce the particle size to a size within the admissible range. In an example, the second mixer may be an ultrasonic generator mechanically coupled to a sonotrode to disperse a printing fluid passing through the second chamber. Then, upon re-dispersion of the particles of the printing fluid, the printing fluid is routed towards the printing fluid tank.

In some examples, each of the first chamber and the second chamber may be sized such that printing fluid compositions are not within each of the first chamber and the second over long periods of time. In some examples, storing printing fluid compositions in the first chamber and the second chamber for a long time may result in solids of the printing fluid settling down. In some examples, printing fluid may settle down as a result of long periods of non-usage (for instance, during power outage, weekends, or idle times). In some examples, the first chamber and the second chamber may have a volume within a range from 15 ml to 65 ml. In some other examples, the first chamber and the second chamber may have a volume within a range from 20 ml to 50 ml. In some examples, the first chamber and the second chamber may be arranged to have the same volume. In some other examples, the first and the second chamber may be sized based on a printing fluid consumption of a printing system associated with the printing fluid tank fluidly connected to the mixing device.

Referring now to FIG. 1, a mixing device 100 comprising a first chamber 110 and a second chamber 120 is shown. The mixing device 100 may be used for adjusting a solid-to-liquid weight ratio of a printing fluid stored in a printing fluid tank 101 (shown in dashed line in FIG. 1). The mixing device 100 further comprises a printing fluid pump 130 to move printing fluid to the printing fluid tank 101. In an example, the pump 130 is to move printing fluid towards the printing fluid tank 101 via an outlet port of the mixing device 100, the outlet port being fluidly connected to an outlet of the second chamber 120. The mixing device 100 further comprises a controller 140. In the mixing device 100 of FIG. 1, the pump 130 is located in between the first chamber 110 and the second chamber 120. However, in other examples, the pump 130 may be positioned in alternative positions (such as a pump located upstream the first chamber 110 of the mixing device 100 or downstream the second chamber 120).

The first chamber 110 of the mixing device 100 comprises a solute addition member 115 and a first mixer 111. As previously explained, as the pump 130 supplies the first chamber 110 with printing fluid, the solute addition member 115 adds solids and the first mixer 111 mixes the added solids with the printing fluid. In FIG. 1, the first chamber 110 receives printing fluid from an auxiliary printing fluid tank 102 (represented in dashed line). In an example, the first chamber 110 may receive printing fluid via an inlet port of the mixing device 100, the inlet port being fluidly connected to the first chamber 110.

As previously explained, the first mixer 111 is to mix the solids added by the solute addition member 115 with the printing fluid such that the resulting particle size at an outlet of the first chamber 110 is about 2 mm. In an example, the solute addition member 115 may provide the first chamber 111 with solids at a solid feed rate within a range from 10 grams/minute to 60 grams/minute. To move the printing fluid through the mixing device 100, the mixing device 100 includes the pump 130. In some examples, the pump 130 may operate at a constant flowrate. However, in other examples, a pump flowrate may be controlled based on a composition adjustment for the printing fluid in the printing fluid tank 101. In an example, the pump may operate to provide a pump flowrate within a range from 80 grams/minute to 450 grams/minute. In an example, the pump flowrate may be within a range from 130 grams/minute to 400 grams/minute.

The controller 140 of the mixing device 100 is operatively connected to the solute addition member 115, the pump 130, the first mixer 111, and the second mixer 121. In the mixing device 100, the controller 140 is to control the solute addition member 115 and the pump 130 based on a printing fluid density level in the printing fluid tank 101 and the first mixer 111 and the second mixer 121 to mix the added solids with the printing fluid moved by the pump 130. In other words, as the pump 130 moves printing fluid towards the printing fluid tank 101 via the first chamber 110 and the second chamber 120 based on the printing fluid density level, the solute addition member 115 add solids to the first chamber 110 based on the printing fluid density level, the first mixer 111 is to mix the added solids with printing fluid, and the second mixer 121 is to mix the printing fluid within the second chamber 120.

As used herein, the term “controller” will be used to refer to any combination of hardware and programming to implement the functionalities described herein. In some examples, such combinations of hardware and programming may be implemented in a number of different ways. For example, the programming of modules may be processor-executable instructions stored on at least one non-transitory machine-readable storage medium and the hardware for modules may include at least one processor to execute those instructions. In some other examples, multiple modules may be collectively implemented by a combination of hardware and programming, as described above. In some other examples, the functionalities of the controller may be, at least partially, implemented in the form of electronic circuitry.

In some examples, the controller 140 may control the solute addition member 115 to provide the first chamber 110 with solids at a solid feed rate based on the printing fluid density level, and the controller 140 may control the pump 130 to modify a pump flowrate based on the printing fluid density level. In some other examples, the controller 140 may control the pump 130 to move printing fluid towards the printing fluid tank 101 at a constant flowrate and the controller 140 may control the solute addition member 115 to add solids at a solid feed rate based on the printing fluid density level. In an example, the printing fluid density level may be associated with a current density of printing fluid stored in the printing fluid tank 101. In some examples, the current density in the printing fluid tank 101 may be measured via a sensor in the printing fluid tank 101. In other examples, the printing fluid density level may be determined as a function in view of a printing fluid usage over a transfer operation. In some other examples, the printing fluid density level may be determined based on a printing fluid density of a recovered printing fluid. The printing fluid density of the recovered printing fluid may be measured, for instance, via a sensor.

In other examples, the first chamber 110 may receive printing fluid from the printing fluid tank 101. In an example, the first chamber 110 comprises an inlet in fluidic communication with the printing fluid tank 101 (for instance, via a fluid line). In some examples, the controller 140 is to control the pump 130 to move printing fluid towards the printing fluid tank 101 at a constant flowrate and the controller 140 is to modify a solid feed rate of the solute addition member 115 based on the printing fluid density level. However, alternative solutions may be possible. In an example, the controller 140 may control the solute addition member 115 to provide a constant solid feed rate and the pump 130 to move printing fluid towards the printing fluid tank 101 at a pump flowrate based on the printing fluid density level. In other examples, the controller 140 may control each of the solute addition member 115 and the pump 130 based on the printing fluid density level.

In some other examples, the controller 140 may further control the first mixer 111 and the second mixer 121. In an example, the controller 140 may control the first mixer 111 and the second mixer 121 based on the number of solids added in the first chamber 110 and the amount of printing fluid moved by the pump 130 per unit of time. In some examples, the controller 140 is to control the first mixer 111 and the second mixer 121 based on the solid feed rate and the pump flowrate. In an example, when having a higher rate of solid particles in a composition moving through the first or second chamber, a mixing speed of the first mixer 111 and the second mixer 121 may be increased to effectively break the particles present in the composition. Similarly, in other examples, when the composition moving through the first chamber or the second chamber has a lower rate of solid particles in a composition, a mixing speed of the first mixer and the second mixer may be decreased to reduce the energy costs associated with higher mixing speeds.

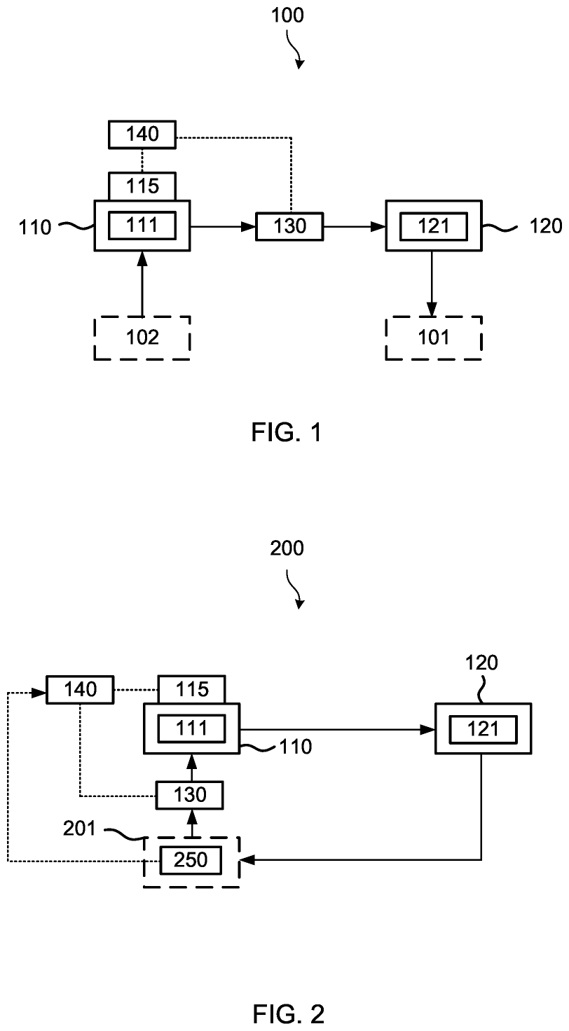

Referring now to FIG. 2, a mixing device 200 comprising a printing fluid density sensor 250 is shown. The elements previously explained in the mixing device 100 have been referenced using the same reference numerals. The mixing device 200 comprises a first chamber 110, a second chamber 120, a printing fluid pump 130, a controller 140, and the printing fluid density sensor 250. The first chamber 110 comprises a first mixer 111 and a solute addition member 115. The second chamber 120 comprises a second mixer 121. The controller is operatively connected to the solute addition member 115, the printing fluid pump 130, the first mixer 111, and the second mixer 121. As previously explained, the controller 140 of the mixing device 200 is to control the solute addition member 115 to add solids to the first chamber 110 at a solid feed rate and the pump 130 to move printing fluid at a pump flowrate based on a printing fluid density level.

In the mixing device 200, the printing fluid pump 130 is located upstream the first chamber 110. However, alternative locations may be possible, such as a pump in between the first chamber 110 and the second chamber 120 or a pump located downstream the second chamber 120. In some examples, the first chamber 110 and the second chamber 120 may be substantially air free. As a result, upon turning on the pump 130, the pump 130 will generate a pressure difference that will cause the printing fluid to move towards an outlet of the second chamber 120 via the first chamber 110 and the second chamber 120. As previously explained, in some examples, the first chamber 110 and the second chamber 120 may be sized such that the operation of the pump 130 at a pump flowrate results in a printing fluid flowrate towards the printing fluid tank 201 substantially equal to the pump flowrate. As a result, pigment settlement along the components of the mixing device 200 may be prevented.

In the mixing device 200, the second chamber 120 is fluidly connected to a printing fluid tank 201 and the first chamber 110 is to receive printing fluid from a printing fluid tank 201 via the pump 130. The mixing device 200 comprises the printing fluid density sensor 250 in the printing fluid tank 201 (e.g., inside the printing fluid tank 201). The printing fluid density sensor 250 measures a printing fluid density in the printing fluid tank 201 and is operatively connected to the controller 140. Upon measurement, the printing fluid density sensor 250 is to send signals associated with the measured printing fluid density to the controller 140. In an example, the controller 140 is to determine the printing fluid density level based on the received signals. In an example, the controller 140 may control the solute addition member 115 to increase a solid feed rate upon determining a printing fluid density below than a first threshold value. In some other examples, the controller 140 may control the solute addition member 115 to decrease the solid feed rate upon determining a printing fluid density above a second threshold value. In an example, the first threshold value may correspond to 1.9% of solids by weight and the second value may correspond to 2.1% of solids by weight. In some examples, the first threshold value may correspond to 14.6 to 16.1 grams of solids per liter of printing fluid.

As previously explained in reference to the mixing device 100 of FIG. 1, as the pump 130 moves printing fluid towards the printing fluid tank 201 based on the printing fluid density level, the controller 140 controls the solute addition member 115 to add solids to the first chamber 110 based on the printing density level, and the controller controls the first mixer 111 and the second mixer 121 to mix the added solids with printing fluid moved by the pump 130. As a result, the solid-to-liquid weight ratio in the printing fluid tank 201 is modified by supplying the printing fluid tank with printing fluid having solid particles with an admissible particle size.

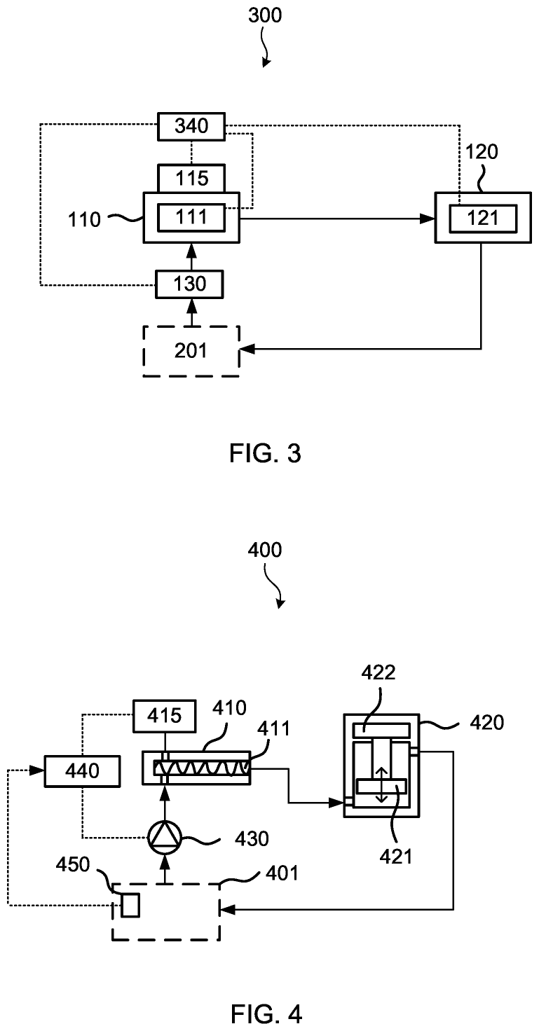

Referring now to FIG. 3, a mixing device 300 including a controller 340 to control a first mixer 111 in a first chamber 110 and a second mixer 121 in a second chamber 120 is shown. The mixing device 300 comprises the first chamber 110, the second chamber 120, a pump 130 upstream the first chamber 110, and the controller 340. The first chamber 110 comprises the first mixer 111 and a solute addition member 115. The second chamber 120 comprises the second mixer 121. The pump 130 is to move printing fluid towards a printing fluid tank 201 via the first chamber 110 and the second chamber 120. In the mixing device 300, the first chamber 110 is to receive printing fluid from the printing fluid tank 201.

The controller 340 of the mixing device 300 is operatively connected to the solute addition member 115, the pump 130, the first mixer 111, and the second mixer 121. As previously explained in reference to the mixing devices 100 and 200, the controller 340 may control the pump 130 to modify a pump flowrate based on a printing fluid density level associated with the printing fluid stored in the printing fluid tank 201. Similarly, the controller 340 may control the solute addition member 115 to modify a solid feed rate based on the printing fluid density level. In some examples, the mixing device 300 may further comprise a printing fluid density sensor to measure a printing fluid density of the printing fluid stored in the printing fluid tank 201.

In the mixing device 300, the controller 340 is further to control the first mixer 111 and the second mixer 121 based on the operation of the pump 130 and the solute addition member 115. In particular, the controller 340 is to control the first mixer 111 to modify a first mixer speed and to control the second mixer 121 to modify a second mixer speed based on the pump flowrate and the solid feed rate. The mixer speeds may be modified, for instance, by modifying an input voltage received by the mixers. In some examples, the controller 340 is to control the first mixer 111 and the second mixer 121 based on the solid feed rate of the solute addition member 115 and the pump flowrate of the pump 130. In an example, the first mixer 111 and the second mixer 121 may increase their mixing speeds upon a solid-to-liquid weight ratio of printing fluid and solids moving through the first chamber 110 and the second chamber 120 increases over time.

In some examples, the first mixer 111 of the mixing device 300 may correspond to an inline mixer. In some examples, mixing the added solids with the inline mixer may comprise rotating a 50 mm impeller at 3000 rpm to reduce the solids to particle sizes up to 1 mm. In some examples, a mixer speed for the inline mixer may be a speed within a range from 1500 rpm to 5000 rpm. In other examples, alternative shapes and dimensions for the inline mixer may be possible.

In some other examples, the second mixer 121 may correspond to a sonotrode mechanically connected to an ultrasonic generator. In some examples, the sonotrode may mix the printing fluid within the second chamber 120 by performing a movement having an amplitude within a range from 5 to 100 microns and a frequency of within a range from 20 KHz to 40 KHz. In an example, the amplitude may be 25 microns and the frequency 24 KHz.

As used herein, the term “sonotrode” generally refers to a mixing element to create ultrasonic vibrations and subsequently applying this vibrational energy to a gas, liquid, solid or tissue. In an example, a sonotrode may include a tapering metal bar commonly used for augmenting the oscillation displacement amplitude provided by an ultrasonic transducer operating at the low end of the ultrasonic frequency spectrum. In some examples, a sonotrode may include a head having a head height of 10 mm and a sonotrode foot diameter of 15 mm. However, alternative sonotrode geometries may be possible.

Referring now to FIG. 4, a mixing device 400 comprising an inline mixer 411 in a first chamber 410 and a sonotrode 421 in a second chamber 420 is shown. The mixing device 400 further comprises a pump 430 upstream the first chamber 410, a controller 440, and a printing fluid density sensor 450 to measure a printing fluid density, the printing fluid density sensor 450 being within a printing fluid tank 401. The first chamber 410 comprises the inline mixer 411 and a solute addition member 415. The second chamber comprises the sonotrode 421 and an ultrasonic generator 422 mechanically connected to the sonotrode 421.

In the mixing device 400, the printing fluid density sensor 450 is to measure a printing fluid density and to send signals associated with measurements to the controller 440. The controller 440, based on the received signals, is to determine a printing fluid density level. Then, the controller 440 is to control the pump 430 to modify a pump flowrate based on the printing fluid density level and to control the solute addition member 415 to modify a solid feed rate based on the printing fluid density level. In some examples, the controller 440 may further receive signals associated with a fluid consumption rate for the printing fluid tank 401. Based on the signals, the controller 440 may further modify the pump flowrate and the solid fee rate such that a solid-to-liquid weight ratio in the printing fluid tank 401 is maintained under admissible values.

In some examples, the controller 440 may be further to control a mixing operation in each of the inline mixer 411 and the sonotrode 421. In an example, the controller 440 may modify an input voltage for a motor (not shown in FIG. 4) mechanically connected to the inline mixer 411 and an input voltage of the ultrasonic generator 422. In some examples, the controller 440 may modify a first mixer speed of the inline mixer and a second mixer speed of the sonotrode 421 based on a solid feed rate and a pump flowrate.

In some other examples, the second chamber 420 may further comprise a cooling member to cool down the second chamber 420. In some examples, the cooling member may be configured to keep a temperature within the second chamber 420 below than 30° C. In some examples, the cooling member may comprise an outer jacket covering an outer surface of the second chamber 420 and a cooling agent source to supply the outer jacket with cooling agent.

According to some examples, a method for modifying a solid-to-liquid weight ratio of a printing fluid stored in a printing fluid tank may be carried out to reduce the image quality defects resulting from a non-uniform solid-to-liquid weight ratio over the transfer operation(s). The method may comprise moving printing fluid to a printing fluid tank via a first chamber a second chamber based on a printing fluid density level in the printing fluid tank, dissolving in the first chamber solids with printing fluid to obtain a concentrated printing fluid based on the printing fluid density level, mixing the concentrated printing fluid in the first chamber, and mixing the concentrated printing fluid in the second chamber.

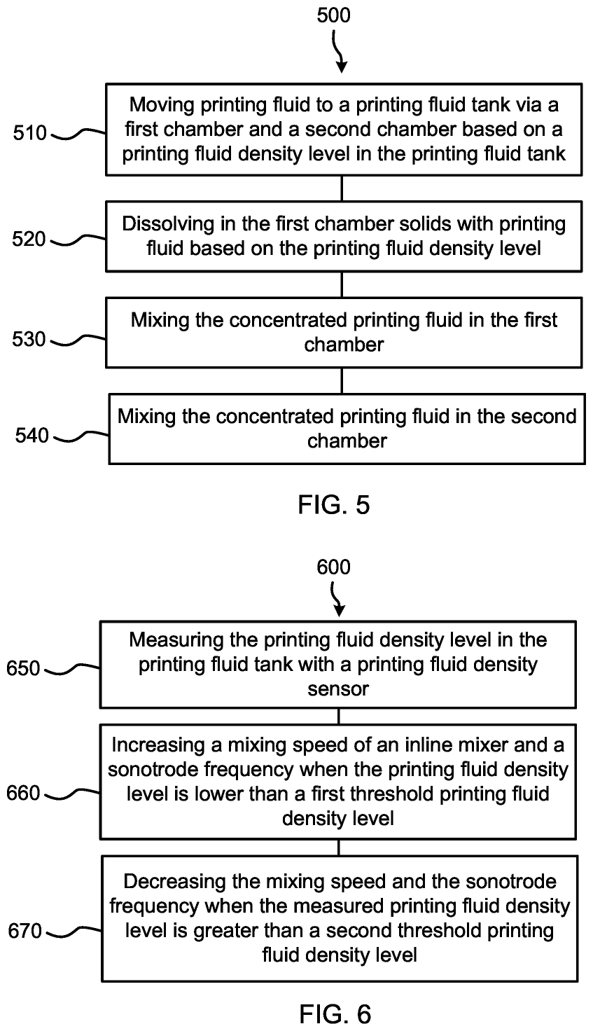

Referring now to FIG. 5, a method 500 for printing fluid dispersion is shown. Method 500 may be carried out to modify a solid-to-liquid weight ratio of a printing fluid stored in a printing fluid tank. Method 500 may be performed, for instance, using any of the mixing devices 100, 200, 300 and 400 previously explained in FIGS. 1 to 4. At block 510, method 510 comprises moving printing fluid to a printing fluid tank via a first chamber and a second chamber based on a printing fluid density level in the printing fluid tank. As previously explained, the second chamber is to receive printing fluid from the first chamber. Accordingly, the second chamber is in fluidic communication with the first chamber and the printing fluid tank. In an example, block 510 may be performed using a pump of the mixing device (for instance, pumps 130 and 430). At block 520, method 500 comprises dissolving in the first chamber solids with printing fluid based on the printing fluid density level. Upon addition of the solids, a concentrated printing fluid is obtained in the first chamber. In some examples, block 520 may comprise adding solids with a solute addition member to the first chamber at a solid feed rate, the solid feed rate being based on a printing fluid density level in the printing fluid tank. In an example, the solids added by the solute may comprise a particle size within a range from 5 mm to 10 mm. At block 530, method 500 comprises mixing the concentrated printing fluid in the first chamber. In some examples, mixing the concentrated printing fluid in the first chamber may comprise breaking solid particles of the concentrated printing fluid to a particle size lower than 2 mm (e.g., 1 mm). Then, at block 540, method 500 comprises mixing the concentrated printing fluid in the second chamber. In some examples, mixing the concentrated printing fluid in the second chamber comprises breaking solid particles of the concentrated printing fluid to a particle size lower than 25 microns.

In some examples, mixing the concentrated printing fluid in the first chamber at block 530 may comprise mixing the concentrated printing fluid with an inline mixer and mixing the concentrated printing fluid in the second chamber at block 540 may comprise mixing the concentrated printing fluid with a sonotrode mechanically connected to an ultrasonic generator.

In other examples, method 500 may further comprise measuring the printing fluid density level in the printing fluid tank with a printing fluid density sensor located in the printing fluid tank. In some other examples, method 500 may further comprise determining a printing fluid consumption rate in the printing fluid tank and moving printing fluid to the printing fluid tank at block 510 may comprise moving printing fluid at a flowrate greater than the printing fluid consumption rate. In an example, the printing fluid consumption rate may be associated with a printing fluid consumption during a transfer operation carried out by the printing system.

In some other examples, dissolving in the first chamber solids with printing fluid based on the printing fluid density level at block 520 comprises adding 10% to 15% of solid particles by printing fluid weight to the first chamber. In some examples, adding 10% to 15% of solid particles by printing fluid weight comprises adding up to 60 grams of solid per minute. In an example, moving the printing fluid to a printing fluid tank via the first chamber and the second chamber based on the printing fluid density level at block 510 comprises moving printing fluid at a flowrate within a range from 70 grams/minute to 275 grams/minute. In some other examples, the pump flowrate may be within a range from 85 to 255 grams/minute.

In further examples, mixing the concentrated printing fluid in the first chamber comprises moving a 50 mm impeller at an angular speed within a range from 1500 rpm to 5000 rpm. In some other examples, mixing the concentrated printing fluid in the second chamber at block 540 comprises moving a sonotrode with an amplitude within a range from 5 to 100 microns and a frequency within a range from 20 KHz to 40 KHz.

As previously explained, in some examples, mixing speeds during a mixing operation carried out in a first chamber and during a mixing operation carried out in a second chamber may be modified to effectively reduce a particle size of the solids contained in the concentrated printing fluid. In an example, mixer speeds may be modified in view of a proportion of solids by weight rate resulting from a solid feed rate of the solute addition member and a pump flowrate of the pump. In some examples, an input voltage of a first mixer in the first chamber and a second mixer in the second chamber may be modified based on the proportion of solids by weight rate.

Referring now to FIG. 6, a method 600 for modifying a mixing speed of an inline mixer in a first chamber and a frequency of a sonotrode in a second chamber is shown. In an examples, method 500 previously explained in reference to FIG. 5 may further comprise blocks 650, 660, and 670 of method 600.

At block 650, method 600 comprises measuring the printing fluid density level in the printing fluid tank with a printing fluid density sensor. Then, at block 660, method 600 comprises increasing a mixing speed of an inline mixer and a sonotrode frequency when the measured printing fluid density level is lower than a first threshold printing fluid density level. In an example, increasing the mixing speed of the inline mixer may comprise increasing an input voltage of a motor mechanically connected to the inline mixer and increasing the sonotrode frequency may comprise increasing an input voltage of an ultrasonic generator mechanically connected to the sonotrode. Then, at block, 670, method 600 comprises decreasing the mixing speed and the sonotrode frequency when the measured printing fluid density level is greater than a second threshold printing fluid density level. In an example, the first threshold printing fluid density level may be 1.9% of solids by total weight and the second threshold printing fluid density level may be 2.1% of solids by total weight. However, alternative values may be possible, such as a first threshold printing fluid density level corresponding to 2.2% of solids by total weight and a second threshold printing fluid density level corresponding to 2.4% of solids by total weight. Other possible ranges may be defined as ±0.1% with respect to a target percentage of solids by total weight associated with stable colors.

According to some examples, a printing system may comprise a printing fluid tank and a mixing device for modifying a solid-to-liquid weight ratio in the printing fluid stored in the printing fluid tank.

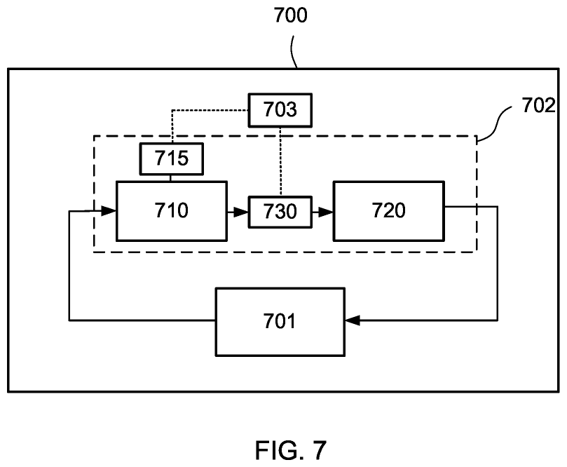

Referring now to FIG. 7, a printing system 700 comprising a printing fluid tank 701, a mixing device 702, and a controller 703 is shown. The mixing device 702, which may correspond to any of the mixing devices 100, 200, 300, and 400 previously explained in FIGS. 1 to 4, comprises a first chamber 710 to receive printing fluid, a second chamber 720 to receive enriched printing fluid from the first chamber 710, and a printing fluid pump 730. The first chamber 710 comprises a first mixing member and a solid addition member 715. The second chamber 720 comprises a second mixing member. The controller 703 of the printing system 700 is to control the solid addition member 715 and the pump 730 based on a printing fluid density level in the printing fluid tank 701. As previously explained, the first mixing member and the second mixing member may be used for reducing an average particle size of the solids added by the solid addition member 715 to admissible levels. As a result, the enriched printing fluid can be effectively mixed with printing fluid stored in the printing fluid tank 701 while modifying the solid-to-liquid weight ratio of the printing fluid in the printing fluid tank 701.

In the mixing device 702, the pump 730 supplies the first chamber 710 with printing fluid. In the printing system 700, the printing fluid is pumped from the printing fluid tank 701. Then, at the first chamber, the solid addition member 715 dissolves solids with printing fluid to obtain an enriched printing fluid. As the solid addition member 715 adds solids to the first chamber 710, the first mixing member reduces an average particle size of solids present in the first chamber 710. In some examples, the first mixing member is to reduce the average particle size to particle sizes lower than 2 mm. To move the enriched printing fluid towards the printing fluid tank 701, the pump 730 moves the enriched printing fluid to the printing towards the printing fluid tank 701 via the second chamber 720. Upon the second chamber 720 receives the enriched printing fluid, the second mixing member in the second chamber 720 is to reduce the average particle size of solids present in the second chamber 720. In some examples, the second mixing member may reduce the particle size to particle sizes lower than 25 microns.

In the printing system 700, the controller 703 is operatively connected to the solid addition member 715 and the pump 730. In particular, the controller 703 is to control a solid feed rate provided by the solid addition member 715 and a pump flowrate based on a printing fluid density level in the printing in the printing fluid tank 701. In an example, the controller 703 may control the pump 730 to provide at a constant flowrate and may control the solid addition member 715 to provide a solid feed rate based on the printing fluid density level. In an example, the controller 703 may increase the solid feed rate upon a printing fluid density level in the printing fluid tank 701 is lower than a threshold value.

In an example, the printing system 700 may further comprise a printing fluid density sensor in the printing fluid tank 701. In an example, the printing fluid density sensor may be operatively connected to the controller 703 of the printing system 700, and the controller 703 may determine a printing fluid density level in the printing fluid tank 701 based on the measurements of the printing fluid density sensor.

In some other examples, the first mixing member in the first chamber 710 comprises an inline mixer and the second mixing member in the second chamber 720 comprises a sonotrode mechanically connected to an ultrasonic generator. In some examples, the controller 703 is to control the inline mixer and the ultrasonic generator based on the printing fluid density level. In some examples, the controller 703 may modify a mixer speed of the inline mixer and a sonotrode frequency of the sonotrode based on the printing fluid density level. By modifying the mixer speed and the sonotrode frequency, the average particle size in each of the first chamber 710 and the second chamber 720 may be effectively reduced even if a pump flowrate and/or a solid feed rate is modified.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

What is claimed is:

1. A mixing device comprising:
a first chamber to receive printing fluid, the first chamber comprising a solute addition member and a first mixer;
a second chamber fluidly connected to the first chamber and to a printing fluid tank, the second chamber comprising a second mixer;
a printing fluid pump; and
a controller operatively connected to the solute addition member, the pump, the first mixer, and the second mixer, the controller to control:
the pump to move printing fluid towards the printing fluid tank via the first chamber and the second chamber based on a printing fluid density level in the printing fluid tank,
the solute addition member to add solids to the first chamber based on the printing fluid density level, and
the first mixer and the second mixer to mix the added solids with printing fluid moved by the pump.

2. The mixing device of claim 1, wherein the controller is to control the pump to move printing fluid towards the printing fluid tank at a constant flowrate and the controller is to control the solute addition member to add solids at a solid feed rate based on the printing fluid density level.

3. The mixing device of claim 1, wherein the solute addition member is to provide solids at a solid feed rate and the pump is to move printing fluid at a pump flowrate, wherein the controller is to control the first mixer and the second mixer to mix the added solids with printing fluid moved by the pump based on the solid feed rate and the pump flowrate.

4. The mixing device of claim 1, wherein:
the first mixer is an inline mixer, and
the second mixer comprises a sonotrode mechanically connected to an ultrasonic generator.

5. The mixing device of claim 1, further comprising a printing fluid density sensor operatively connected to the controller, the printing fluid density sensor to:
measure a printing fluid density in the printing fluid tank, and
send signals associated with the measured printing fluid density to the controller,
wherein the controller is to determine the printing fluid density level based on the received signals.

6. The mixing device of claim 1, wherein the controller is to control:
the solute addition member to provide solids at a solid feed rate within a range from 10 grams/minute to 60 grams/minute based on the printing fluid density level, and
the pump to move printing fluid at a pump flowrate within a range from 80 grams/minute to 450 grams/minute based on the printing fluid density level.

7. A method for printing fluid dispersion, the method comprising:
moving printing fluid to a printing fluid tank via a first chamber and a second chamber based on a printing fluid density level in the printing fluid tank, the second chamber in fluidic communication with the first chamber and the printing fluid tank;
dissolving in the first chamber solids with printing fluid to obtain a concentrated printing fluid based on the printing fluid density level;
mixing the concentrated printing fluid in the first chamber; and
mixing the concentrated printing fluid in the second chamber.

8. The method of claim 7, further comprising:
determining a printing fluid consumption rate in the printing fluid tank;
wherein moving printing fluid to the printing fluid tank via the first chamber and a second chamber comprises moving printing fluid at a flowrate greater than the printing fluid consumption rate.

9. The method of claim 7, further comprising:
measuring the printing fluid density level in the printing fluid tank with a printing fluid density sensor located in the printing fluid tank.

10. The method of claim 9, wherein mixing the concentrated printing fluid in the first chamber and dispersing the concentrated printing fluid comprises:
increasing a mixing speed of an inline mixer in the first chamber and a sonotrode frequency of a sonotrode in the second chamber when the measured printing fluid density level is lower than a first threshold printing fluid density level, and
decreasing the mixing speed and the sonotrode frequency when the measured printing fluid density level is greater than a second threshold printing fluid density level.

11. The method of claim 7, wherein dissolving solids with printing fluid in the first chamber comprises adding 10% to 15% of solid particles by printing fluid weight to the first chamber.

12. The method of claim 11, wherein mixing the concentrated printing fluid in the second chamber comprises moving a sonotrode with an amplitude within a range from 5 to 100 microns.

13. A printing system comprising:
a printing fluid tank;
a mixing device comprising:
a first chamber comprising a solid addition member to dissolve solids with printing fluid to obtain an enriched printing fluid and a first mixing member to reduce an average particle size of solids present in the first chamber,
a second chamber to receive the enriched printing fluid from the first chamber, the second chamber comprising a second mixing member to reduce the average particle size of solids present in the second chamber, and
a pump to supply the first chamber with printing fluid and to move enriched printing fluid towards the printing fluid tank via the second chamber; and
a controller to control the solid addition member and the pump based on a printing fluid density level in the printing fluid tank.

14. The printing system of claim 13, wherein the first mixing member comprises an inline mixer and the second mixing member comprises a sonotrode mechanically connected to an ultrasonic generator, the controller to control the inline mixer and the ultrasonic generator based on the printing fluid density level.

15. The printing system of claim 13, further comprising a printing fluid density sensor in the printing fluid tank and operatively connected to the controller, the printing fluid density sensor to measure a printing fluid density and the controller to determine the printing fluid density level based on the measurements of the printing fluid density sensor.
